(19) United States
(12) Patent Application Publication
(10) Pub. No.: US 2007/0046530 A1
(43) Pub. Date: Mar. 1, 2007

(54) Methods and systems for satellite navigation

(75) Inventor: Neal R. Fedora, Cleanwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/211,382

(22) Filed: Aug. 25, 2005

(51) Int. Cl. G01S 5/14; H04B 7/185

(52) U.S. Cl. 342/357.01

(57) ABSTRACT

Systems and methods for satellite navigation are provided. In one embodiment, a mobile unit for a satellite navigation system is disclosed. The mobile unit comprises means for transmitting a request radio signal to satellite vehicles; means for receiving a response radio signal, wherein the response radio signal includes orbital coordinates of the one or more satellite vehicles; means for calculating a range to the satellite vehicles by calculating a time difference of arrival range based on a transmitted request radio signal and a received response radio signal, wherein the means for calculating a range is responsive to the means for transmitting a request radio signal and the means for receiving a response radio signal; and means for calculating position based on the range to at least three satellite vehicles and the orbital coordinates of the at least three satellite vehicles responsive to the means for calculating a range.

### TECHNICAL FIELD

The present invention generally relates to navigation and more specifically to satellite based navigation systems and methods.

### BACKGROUND

Missions for exploring extraterrestrial worlds, such as the Moon and Mars, require operating mobile vehicles both above and on the surface of the extraterrestrial worlds. Currently, such vehicles when deployed are not able to accurately ascertain their own position because positioning systems, such as the global positioning system (GPS) on Earth, are not available at these locations. Existing satellite navigation solutions, such as GPS, are too expensive, large and complex to deploy for extraterrestrial applications. For example, each GPS satellite possesses an array of equipment for maintaining a highly accurate orbit and multiple signal transmissions, and requires a highly accurate, and expensive, atomic clock to function.

For the reasons stated above and for other reasons stated below which will become apparent to those skilled in the art upon reading and understanding the specification, there is a need in the art for a low cost general positioning navigation solution for extraterrestrial missions.

### SUMMARY

The Embodiments of the present invention provide methods and systems for satellite navigation and will be understood by reading and studying the following specification.

In one embodiment, a mobile unit for a satellite navigation system is provided. The mobile unit comprises a radio transmitter; a processor coupled to the radio transmitter, wherein the processor is adapted to transmitting one or more request signals to one or more satellite vehicles via the radio transmitter; and a radio receiver coupled to the processor, wherein the processor is further adapted to receiving response signals from the one or more satellite vehicles, wherein the response signals include one or more of orbital coordinates of the one or more satellite vehicles, a mobile unit identification code, a satellite vehicle identification code, a processing delay factor, and a health status code. The processor is further adapted to calculate a range to the one or more satellite vehicles by calculating a time difference of arrival range based on the request signals and the response signals. When the processor receives response signals from at least three satellite vehicles of the one or more satellite vehicles, the processor is further adapted to calculate position based on the range to the at least three satellite vehicles and the orbital coordinates of the at least three satellite vehicles.

In another embodiment, a method for determining position of a mobile unit on a body is provided. The method comprises transmitting one or more request signals to three or more satellite vehicles orbiting the body; receiving response signals from at least three satellite vehicles, wherein the response signals include one or more of orbital coordinates of the at least three satellite vehicles, a mobile unit identification code, a satellite vehicle identification code, a processing delay factor, and a health status code; and determining position based on a time difference of arrival range to the at least three satellite vehicles and the orbital coordinates of the at least three satellite vehicles.

In yet another embodiment, a mobile unit for a satellite navigation system is provided. The mobile unit comprising means for transmitting a request radio signal to one or more satellite vehicles; means for receiving a response radio signal from the one or more satellite vehicles, wherein the response radio signal includes orbital coordinates of the one or more satellite vehicles; means for calculating a range to the one or more satellite vehicles by calculating a time difference of arrival range based on a transmitted request radio signal and a received response radio signal, wherein the means for calculating a range is responsive to the means for transmitting a request radio signal and the means for receiving a response radio signal; and means for calculating a position based on the range to at least three satellite vehicles and the orbital coordinates of the at least three satellite vehicles, responsive to the means for calculating a range.

### DRAWINGS

The present invention can be more easily understood and further advantages and uses thereof more readily apparent, when considered in view of the description of the preferred embodiments and the following figures in which:

FIG. 1A is a diagram illustrating triangulation between a mobile unit and satellite vehicles of one embodiment of the present invention;

FIG. 1B is a block diagram of a mobile unit of one embodiment of the present invention;

FIG. 2 is a block diagram of a satellite vehicle of one embodiment of the present invention;

FIG. 3 is a flow chart illustration a method of one embodiment of the present invention;

FIG. 4 is a flow chart illustrating a method of one embodiment of the present invention;

FIG. 5A is a diagram illustrating calibration of a satellite vehicle by a support station of one embodiment of the present invention;

FIG. 5B is a block diagram of a support station of one embodiment of the present invention; and

FIG. 6 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

As described and illustrated in detail below, embodiments of the present invention are comprised of three main sub-systems: 1) a system of orbiting satellite vehicles each aware of their current positions in space, 2) at least one support station adapted to calibrate each satellite vehicle's position and clock bias, and 3) a mobile unit in communication with at least three of the orbiting satellite vehicles. Unlike GPS satellite positioning systems available in the art today, embodiments of the present invention do not require each satellite to possess a highly accurate atomic clock because embodiments of the present invention do not rely on time of arrival (TOA) methods to calculate position. TOA methods determine range based on the time it takes one object to receive a signal transmitted by a second object. TOA requires a high degree of clock synchronization between the two objects to ensure accurate measurements. Instead, embodiments of the present invention utilize time difference of arrival (TDOA) methods with satellite vehicles that are periodically calibrated. Unlike TOA methods, TDOA determines the range of a first object from a second as a function of the round trip time it take for the first object to transmit a signal to the second object, and receive a response signal back from the second object. The round trip time can be measured entirely by the first object without the need for clock synchronization between the two objects.

Although the examples of embodiments provided in this specification are described in terms of a lunar satellite positioning system for Earth's moon, embodiments of the present invention are not limited to applications for Earth's moon. To the contrary, embodiments of the present invention are applicable to any other extraterrestrial body, such as but not limited to the planet Mars, extraterrestrial moons, such as but not limited to the moons of Saturn or Jupiter, or other extraterrestrial bodies. Additionally, there are no limitations preventing embodiments of the present invention from being utilized to establish an alternative satellite positioning system for the Earth.

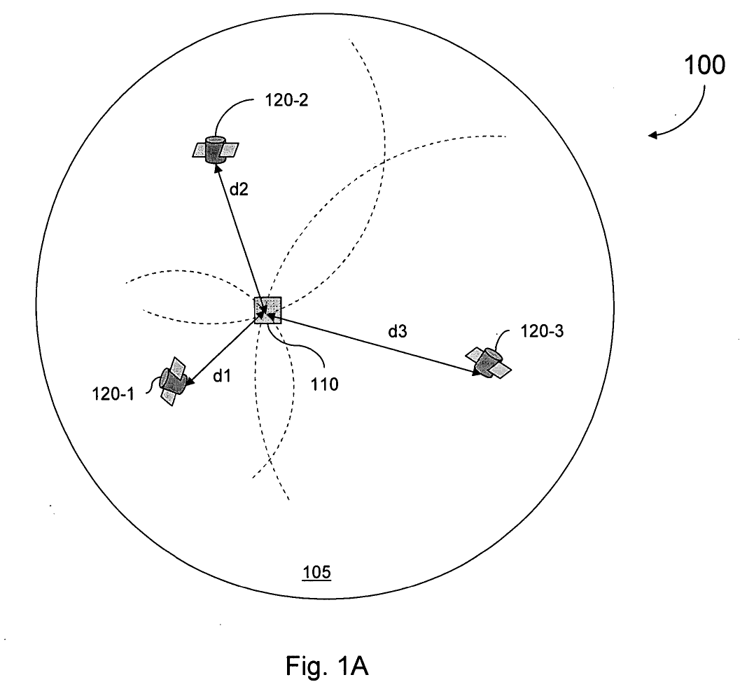

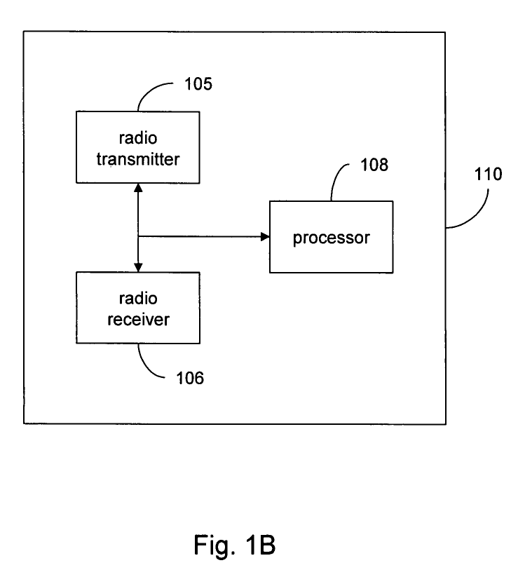

Illustrated in FIG. 1A, a mobile unit 110 of one embodiment of the present invention determines its own position relative to lunar surface 105 by triangulating against known positions of three or more orbiting satellite vehicles (SVs), such as SV 120-1, SV 120-2 and SV 120-3. In one embodiment, mobile unit 110 comprises a radio transmitter 105, a radio receiver 106, and a processor 108, as illustrated in FIG. 1B. As will be explained in more detail later in this specification, SV 120-1, SV 120-2, and 120-3, each know their own current position coordinates in orbit as described below. In one embodiment, mobile unit 110 transmits a radio signal which is received by each of SVs 120-1 to 120-3. SVs 120-1 to 120-3 each respond to mobile unit 110 by transmitting a signal comprising data that specifies their own location in orbit. Upon receiving the signal transmitted from each SV, mobile unit 110 then determines the range (or distance) between itself and SV 120-1 (shown as distance d1), SV 120-2 (shown as distance d2), and SV 120-3 (shown as distance d3) by calculating the time difference of arrival (TDOA) range for each of the SVs. TDOA range is a function of the time that elapses between mobile unit 110 transmitting a radio signal and receiving a response signal from an SV. In one embodiment, the distance between mobile unit 110 and SV 120-1, for example, is calculated from the formula:

$$d 1 = \frac{2 c}{Δ t - Δ t\_sync}$$

Where c is equal to the speed of light, Δt is equal to the elapsed time between mobile unit 110 transmitting a radio signal and receiving a response signal from SV 120-1, and Δt_sync is a processing delay factor equal to the time for SV 120-1 to internally recognize the signal from mobile unit 110 and transmit its own response signal. In one embodiment, the value of Δt_sync is transmitted to mobile unit 110 in the response signal from SV 120-1. Mobile unit 110 similarly calculates distances d2, and d3 for SVs 120-2 and 120-3 respectively.

By knowing its distances from each of SVs 120-1, 2 and 3, and knowing the location in orbit of SVs 120-1 to 120-3, mobile unit 110 can calculate its own position on lunar surface 105 by any one of several trigonometric formulas, as would be readily appreciated by one skilled in the art upon reading this specification. The exact formulas necessary for mobile unit 110 to calculate the coordinates of its own position would ultimately depend on the coordinate system adopted to specify locations on and above lunar surface 105, which is a completely arbitrary decision for purposes of embodiments of the present invention.

Valid response signals from at least three satellite vehicles is required for a mobile unit 110 to triangulate and calculate its own position on or relative to lunar surface 105. However, as would be appreciated by one skilled in the art upon reading this specification, embodiments of the present invention are not limited to navigation systems with only three orbiting satellite vehicles. In one embodiment, mobile unit 110 is adapted to triangulate with four or more satellite vehicles in order to improve the positioning accuracy.

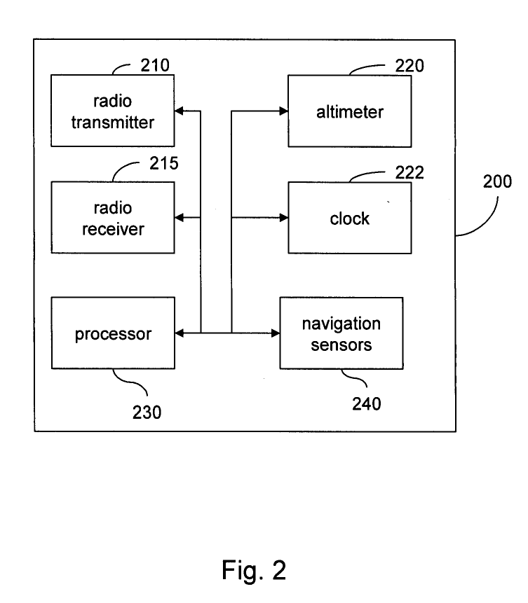

Illustrated in FIG. 2, SV 200 is comprised of a radio transmitter 210, a radio receiver 215, an altimeter 220, and a clock 222, each coupled to a processor 230. In one embodiment receiver 215 receives a request signal from mobile unit 110. In one embodiment, processor 230 responds to the request signal by transmitting SV 200's current location via transmitter 210. (Details pertaining to how processor 230 determines SV 200's current location are provided below.) In one embodiment, the data transmitted back to mobile unit 110 includes one or more of, but not limited to, SV 200's orbital coordinates, Δt_sync, health status data, a unique ID code that identifies and distinguishes SV 200 from other SV's, and the ID code of the mobile unit 110 that SV 200 is responding to.

In one embodiment, SV 200 travels in a polar orbit, passing over both the northern and southern pole of the moon exactly once per orbit. Although embodiments of the present invention are not limited to SVs traveling in a polar orbit, polar orbits have several advantages. First, polar orbit are inherently stable. Second, the use of polar orbits reduces the total number of SVs required to provide a 100% coverage positioning solution. Third, polar orbits reduce the number of support stations required for calibrating the SVs because every SV inherently traveling in a polar orbit will pass over a single support station located at either the northern or southern lunar poles during each orbit. A satellite navigation system of an embodiment of the present invention comprising one or more SVs traveling in non-polar orbits requires those SVs to pass within sufficient proximity of a support station to periodically perform the calibration described later in this specification.

In one embodiment, processor 230 determines SV 200's current orbital coordinates based on coordinates provided from a calibration signal from a support station and the time elapsed since receiving the last calibration signal. For example, in one embodiment SV 200 receives a calibration signal from a support station as SV 200 passes above the lunar north pole. The calibration signal provides SV 200 with its precise coordinates. As SV 200 continues to travel past the north pole, processor 230 can continue to calculate SV 200's current coordinates based on the time elapsed since receiving the calibration signal and SV 200's velocity (which is a known constant as long as SV 200 is maintained in a stable orbit) as it travels around a known circular path. Because SV 200 is recalibrated once each orbit, errors due to clock 222 inaccuracies, velocity changes or orbital path changes do not accumulate excessively.

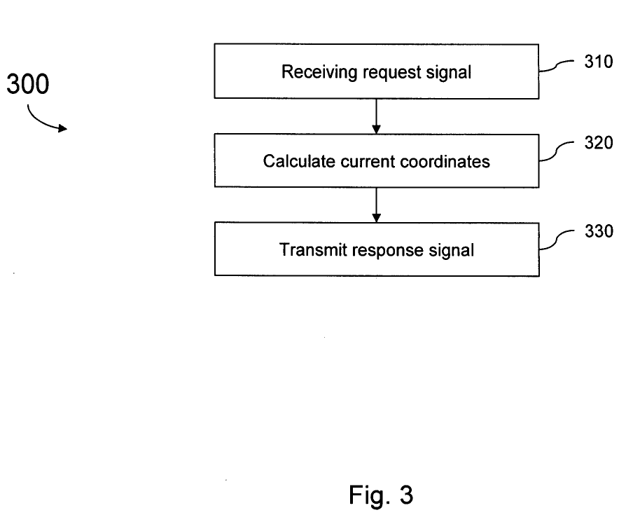

FIG. 3 is a flowchart illustrating a method 300 of one embodiment of the present invention implemented by a SV as describe with respect to FIG. 2. Method 300 comprises receiving a request signal from a mobile unit (310), such as mobile unit 110. In one embodiment, in response to the request signal, the processor determines the elapsed time since the last support station calibration. The processor calculates the current coordinates of the SV at 320. The processor reaches the calculation based on the distance the SV has traveled since calibration, the orbital path of the SV, and the calibration coordinates provided by the support station on the last orbit. In one embodiment, as an option, the processor also determines Δt_sync. In one embodiment, the processor calculates Δt_sync based on the elapsed time required for the processor to receive a request signal, calculate coordinates, and be ready to transmit a response to the mobile unit. In another embodiment, Δt_sync is periodically updated and recalled from memory when needed. In another embodiment, Δt_sync is calculated from the support station, when the station is in view of the SV, and used by the SV for data transmittal.

Because there may be more that one active mobile unit on the lunar surface requesting position data, in one embodiment, a request signal comprises an interrogation code (i.e. for requesting position data from the SV) and a mobile unit ID code for the mobile unit making the request. In one embodiment, when an SV receives a request signal from a mobile unit providing an ID code, the SV response signal further comprises a mobile unit ID code identifying the mobile unit it is responding to. This eliminates the problem of a mobile unit miscalculating the TDOA range based on an SV response signal intended for another mobile unit. Further, because a mobile unit may at times desire to obtain information from a specific SV, a request signal may further comprise an SV ID code for a specific SV. In one embodiment, an SV's processor is adapted not to respond to a request signal comprising an SV ID other than its own.

The SV responds to the mobile unit request signal at 330 by transmitting a response signal. In one embodiment, the response signal includes, but is not limited to, the SV's current coordinates, a Δt_sync, a mobile unit ID code, and an SV ID code.

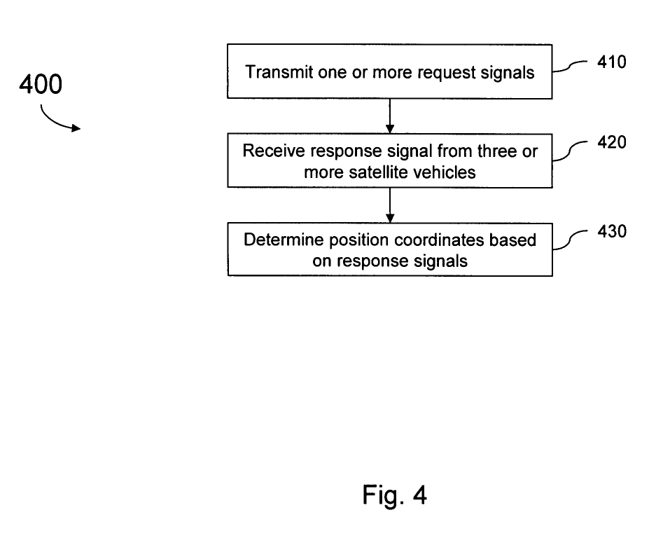

FIG. 4 is a flowchart illustrating a method 400 of one embodiment of the present invention implemented by a mobile unit as describe with respect to FIG. 1. Method 400 comprises transmitting one or more request signals (410) from a mobile unit. In one embodiment, a request signal comprises an interrogation code and a mobile unit ID code identifying the mobile unit making the request. In one embodiment, one request signal is broadcast to elicit responses from at least three SVs. In one embodiment, three or more requests signals are sequentially transmitted by a mobile unit, identifying specific SVs from which responses are desired. Next, method 400 further comprises receiving response signals (420) from three or more SV's. In one embodiment, response signals comprise one or more of the SV ID of the SV responding, the SV's current coordinates, Δt_sync, and a mobile unit ID code identifying the mobile unit it is responding to. In one embodiment, a mobile unit ignores response signals responding to a request signal from a mobile unit other that itself. The mobile unit calculates the range between itself and at least three of the SV's by calculating the TDOA range and based on the coordinates provided by those SVs, triangulates to determine its own position (430).

In one embodiment, each SV processor further performs one or more self-checks on internal systems to determine its own health status. In one embodiment, an SV's response signal further comprises health status data, such as but not limited to a health status flag, enabling a mobile unit receiving the signal to determine whether to include coordinates provided by that SV in triangulation calculations. If an SV indicates that its health status is unsatisfactory, then the support station is adapted to ignore the coordinate data provided by that SV.

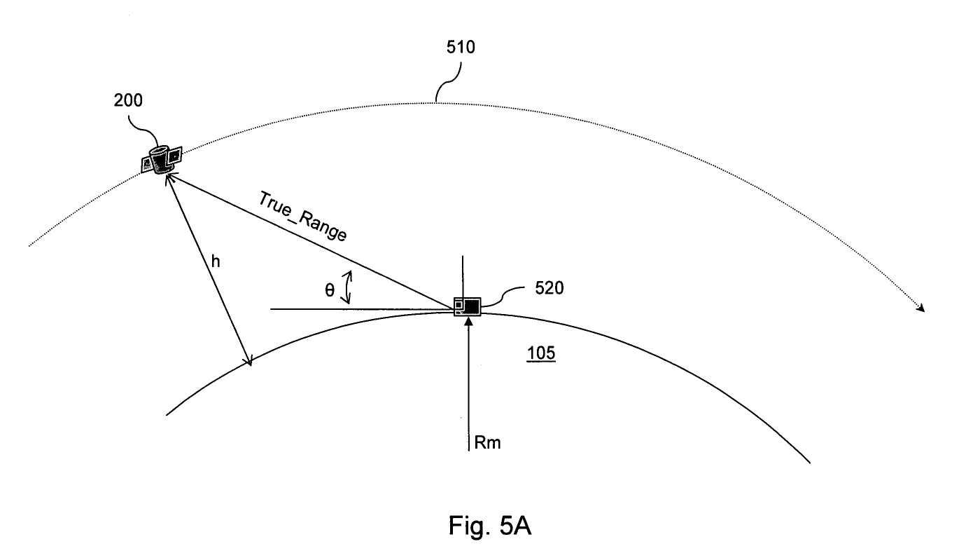

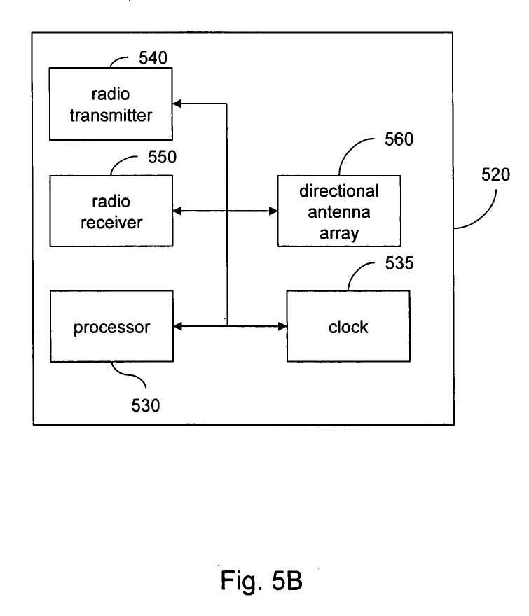

FIGS. 5A and 5B illustrate a support station and the calibration of an SV by a support station, of one embodiment of the present invention. In one embodiment, SV 200, traveling in orbit 510, receives a calibration signal from a support station 520. The calibration signal includes SV 200's calibrated orbital coordinates, which support station 520 determines as follows. In one embodiment, support station 520 comprises a processor 530 coupled to a clock 535, a transmitter 540, a receiver 550, and a directional antenna array 560, as illustrated in FIG. 5B. Processor 530 is adapted to know support station 520's precise coordinates on the lunar surface. In one embodiment, support station 520 transmits an interrogation signal to an approaching SV. In one embodiment, the interrogation signal comprises an interrogation code (i.e. for requesting position data from the SV) and an SV ID. SV 200 is adapted to respond to an interrogation signal from a support station with a response signal comprising SV 200's altitude (h) above lunar surface 105, as determined by altimeter 220. In one embodiment, altimeter 220 comprises one or both of a radar altimeter and a laser altimeter. Processor 530 is further adapted to determine an SV elevation (θ) and azimuth angle based on measuring differences in phase angles of the response signal received by the antennas of directional antenna array 560. Based on the angle θ, altitude (h) and the radius of the Moon (Rm=1738km for Earth's moon), processor 530 is adapted to calculate a true range distance from support station 520 to SV 200 using the formula:
True_Range=\sqrt{h²−(Rm×cos Θ)²}−Rm×sin Θ
Given the true range distance between support station 520 and SV 200, and SV 200's altitude (h) above the lunar surface 105, and SV 200's azimuth, as would be appreciated by one skilled in the art, processor 530 can readily calculate SV 200's calibrated orbital coordinates which can be transmitted in a calibration signal back to SV 200.

In one embodiment, processor 530 can further calculate the precise velocity of SV 200 based on measuring the Doppler shift (i.e. range rate) in the transmitted carrier signal of the range measurement between SV 200 and the support station 530 over some elapse time, commonly referred to as delta range. In one embodiment, the measured Doppler shift delta range would be corrected for the SV 200 clock bias. In another embodiment, SV 200's velocity is quantified by one or more navigation sensors 240, such as, but not limited to, inertial gyros and accelerometers. This velocity measurement can also be transmitted in a calibration signal back to SV 200, for processor 230 to utilize when calculation SV 200's current position as described above.

Additionally, in one embodiment, processor 530 is adapted to calculate Δt_sync for SV 200 and transmit that value in a calibration signal back to SV 200. As described above with respect to FIG. 1, support station 520 can also calculate the range to SV 200 based on a TDOA measurement. The value of Δt_sync for SV 200 can then be calculated as a function of the difference between the TDOA range and True_Range. In one embodiment, utilizing clock 535, processor 530 is adapted to measure the difference in time (Δt) between when it transmits an interrogation signal to SV 200 and when it received a response signal back from SV 200. Processor 530 then calculates the TDOA range to SV 200 using the formula:

$$TDOA\_Range = \frac{2 c}{Δ t}$$

where c is equal to the speed of light. The value of Δt_sync for SV 200 is then determined using the formula:

$$Δ t\_sunc = \frac{TODA\_Range - True\_Range}{c}$$

In one embodiment, this Δt_sync measurement is also transmitted in the calibration signal back to SV 200, for SV 200 to subsequently include in response signals to mobile units.

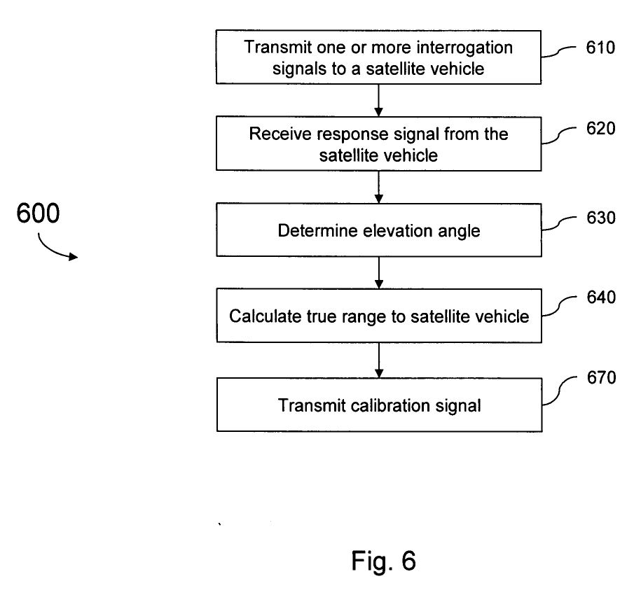

FIG. 6 is a flowchart illustrating a method 600 of one embodiment of the present invention implemented by a support station for calibrating an SV as describe above with respect to FIG. 5. Method 600 comprises transmitting one or more interrogation signals (610) to an SV. In one embodiment, the interrogation signal comprises an interrogation code and an SV ID for the SV. Next, method 600 comprises receiving a response signal (620) from the SV, which comprises data on the SV's altitude (h) above the lunar surface. The method continues with determining the elevation angle (θ) (630) of the SV. In one embodiment, the SV elevation angle (θ) is determined by measuring differences in phase angels of the response signal received by antennas of a directional antenna array. Based on the angle θ, altitude (h) and the radius of the Moon, method 600 further comprises calculating the True_Range distance from the support station to the SV (640) and calculates the calibrated orbital coordinates of the SV. As discussed above, the coordinate system adopted to specify locations on and above the lunar surface is arbitrary for purposes of embodiments of the present invention. The exact formulas necessary to calculate the calibrated orbital coordinates of the SV can be readily determined by one skilled in the art upon reading this specification based on the adopted coordinate system. In one embodiment, method 600 optionally calculates Δt_sync for the SV based on the difference between a TDOA range and True_Range. In one embodiment, the difference in time (Δt) between transmitting one or more interrogation signals and receiving a response signal is measured and the TDOA range is calculated using the formula TDOA_Range=2(c)/Δt, where c is the speed of light. In one embodiment, the value of Δt_sync is then determined using the formula Δt_sync=(TDOA_Range−True_Range)/c. In one embodiment, method 600 also optionally calculates the velocity of SV. In one embodiment, the velocity of the SV is determine based on the measured Doppler shift of the SV's transmitted carrier, also known as delta range. In another embodiment, velocity is measured using one or more range measurements and the elapsed time between the present encounter between the SV and the support station and the previous encounter. Method 600 then comprises transmitting a calibration signal (670) to the SV. In one embodiment, the calibration signal transmitted to the SV comprises one or more of, an SV ID, the calibrated orbital coordinates of the SV, the Δt_sync value for the SV, and the velocity of the SV.

Several means are available to implement the processors discussed with respect to FIGS. 1, 2 and 5 of the current invention. These means include, but are not limited to, digital computer systems, programmable controllers, or field programmable gate arrays. Therefore other embodiments of the present invention are program instructions resident on computer readable media which when implemented by such processors, enable the processors to implement embodiments of the present invention. Computer readable media include any form of computer memory, including but not limited to punch cards, magnetic disk or tape, any optical data storage system, flash read-only memory (ROM), non-volatile ROM, programmable ROM (PROM), electrically erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A mobile unit for a satellite navigation system, the mobile unit comprising:
a radio transmitter;
a processor coupled to the radio transmitter, wherein the processor is adapted to transmitting one or more request signals to one or more satellite vehicles via the radio transmitter; and
a radio receiver coupled to the processor, wherein the processor is further adapted to receiving response signals from the one or more satellite vehicles, wherein the response signals include one or more of orbital coordinates of the one or more satellite vehicles, a mobile unit identification code, a satellite vehicle identification code, a processing delay factor, and a health status code;
wherein the processor is further adapted to calculate a range to the one or more satellite vehicles by calculating a time difference of arrival range based on the request signals and the response signals; and
wherein when the processor receives response signals from at least three satellite vehicles of the one or more satellite vehicles, the processor is further adapted to calculate position based on the range to the at least three satellite vehicles and the orbital coordinates of the at least three satellite vehicles.

2. The mobile unit of claim 1, wherein the request signals comprise one or more of an interrogation code, a mobile unit identification code, and a satellite vehicle identification code.

3. The mobile unit of claim 1, wherein the processor is further adapted to discard data from response signals from one or more satellite vehicles based on one or more of the mobile unit identification code, the satellite vehicle identification code, and the health status code.

4. A satellite vehicle for a satellite navigation system, the satellite vehicle comprising:
a radio receiver;
a processor coupled to the radio receiver, wherein the processor is adapted to receive one or more request signals from one or more mobile units; and
a radio transmitter coupled to the processor;
wherein the processor is further adapted to transmit a first response signal in response to receiving the one or more request signals; and
wherein the first response signal comprises one or more of the satellite vehicle's current orbital coordinates, a processing delay factor, a heath status code, a satellite vehicle identification code, and a mobile unit identification code.

5. The satellite vehicle of claim 4, further comprising:
a clock coupled to the processor;
wherein the processor is further adapted to receive a calibration signal comprising at least one of calibrated orbital coordinates and the value of the processing delay factor; and
wherein the processor is further adapted to calculate the satellite vehicle's current orbital coordinates based on an elapsed time since receiving the calibration signal, a distance traveled since receiving the calibration signal, and the calibrated orbital coordinates received from the calibration signal.

6. The satellite vehicle of claim 5, wherein the processor is further adapted to calculate one or more of the distance traveled since receiving the calibration signal based on a velocity value received from the calibration signal, and the processing delay factor based on an elapsed time required to receive a request signal, calculate current orbital coordinates, and transmit the first response signal.

7. The satellite vehicle of claim 4 further comprising:
an altimeter coupled to the processor;
wherein the processor is further adapted to receive one or more interrogation signals from at least one support station;
wherein the processor is further adapted to transmit a second response signal in response to receiving the one or more interrogation signals; and
wherein the second response signal comprises one or more of the satellite vehicle's current altitude and a satellite vehicle identification code.

8. A support station for a satellite navigation system, the support station comprising:
a radio transmitter;
a processor coupled to the radio transmitter, wherein the processor is adapted to transmit an interrogation signal to one or more satellite vehicles via the radio transmitter;
a radio receiver, the radio receiver adapted to receive a response signal from a satellite vehicle, wherein the response signal comprises the current altitude of the satellite vehicle; and
a directional antenna array coupled to the radio receiver;
wherein the processor is further adapted to determine an elevation angle of the satellite vehicle based on the response signal received, calculate a true range distance to the satellite vehicle based on the satellite vehicle's elevation angle and current altitude, calculate calibrated orbital coordinates of the satellite vehicle based on the true range distance, and transmit a calibration signal comprising the calibrated orbital coordinates of the satellite vehicle.

9. The support station of claim 8, wherein the processor is further adapted to calculate a range to the satellite vehicle by calculating the time difference of arrival range based on the interrogation signals and the response signal;
wherein the processor is further adapted to calculate a processing delay factor for the satellite vehicle based on the difference between the time difference of arrival range and the true range distance; and
wherein the calibration signal further comprises the processing delay factor.

10. The support station of claim 8, wherein the processor is further adapted to calculate an orbital velocity of the satellite vehicle; and
wherein the calibration signal further comprises the orbital velocity of the satellite vehicle.

11. The support station of claim 10, wherein the processor is adapted to calculate the velocity of the satellite vehicle based on one or more of one or more range measurements and an elapsed time between encounters with the satellite vehicle, a delta range measurement calculated from a Doppler shift, and one or more navigation sensors.

12. A method for determining position of a mobile unit on a body, the method comprising:
transmitting one or more request signals to three or more satellite vehicles orbiting the body;
receiving response signals from at least three satellite vehicles, wherein the response signals include one or more of orbital coordinates of the at least three satellite vehicles, a mobile unit identification code, a satellite vehicle identification code, a processing delay factor, and a health status code; and
determining position based on a time difference of arrival range to the at least three satellite vehicles and the orbital coordinates of the at least three satellite vehicles.

13. The method of claim 12, wherein the request signals comprise one or more of an interrogation code, a mobile unit identification code, and a satellite vehicle identification code.

14. The method of claim 12, further comprising:
discarding response signals from one or more satellite vehicles based on one or more of the mobile unit identification code, the satellite vehicle identification code, and the health status code.

15. A mobile unit for a satellite navigation system, the mobile unit comprising:
means for transmitting a request radio signal to one or more satellite vehicles;
means for receiving a response radio signal from the one or more satellite vehicles, wherein the response radio signal includes orbital coordinates of the one or more satellite vehicles;
means for calculating a range to the one or more satellite vehicles by calculating a time difference of arrival range based on a transmitted request radio signal and a received response radio signal, wherein the means for calculating a range is responsive to the means for transmitting a request radio signal and the means for receiving a response radio signal; and
means for calculating a position based on the range to at least three satellite vehicles and the orbital coordinates of the at least three satellite vehicles, responsive to the means for calculating a range.

16. The mobile unit of claim 15, wherein the request radio signals comprise one or more of means for requesting the response radio signal from the one or more satellite vehicles, means to identify the mobile unit, and means to identify the one or more satellite vehicles.

17. The mobile unit of claim 15, wherein the response radio signal comprises one or more of means for communicating the orbital coordinates of the one or more satellite vehicles, means to identify the mobile unit, means to identify the one or more satellite vehicles, means for communicating a processing delay factor, and means for communicating health status.

18. The mobile unit of claim 17, wherein one or both of the means for calculating a range and means for calculating a position are adapted to discard data from response radio signals from one or more satellite vehicles based on one or more of the means to identify the mobile unit, the means to identify the one or more satellite vehicles, and the means for communicating health status.
